(19) United States
(12) Patent Application Publication
(10) Pub. No.: US 2007/0045917 A1
(43) Pub. Date: Mar. 1, 2007

(54) Vibration absorber and light scanning unit having the same

(75) Inventor: Yeonkyu Kim, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/483,780

(22) Filed: Jul. 11, 2006

(30) Foreign Application Priority Data
Aug. 25, 2005 (KR) 2005-78428

(51) Int. Cl. F16F 9/00

(52) U.S. Cl. 267/140.11

(57) ABSTRACT

A vibration absorber includes a support frame installed on a structure, and a damper block portion movably installed on the support frame to change a frequency of the structure while moving on the support frame. The vibration absorber and the light scanning unit having the vibration absorber are manufactured without a precision process because the frequency can be tuned by the movement of mass, not by changing the strength. Also, since the frequency of the vibration absorber can be tuned by manually moving the damper block portion, the vibration absorber may be used in mechanical structures operating under various working environments.

### CROSS-REFERENCE TO RELATED APPLICATIONS

This application claims the benefit of Korean Patent Application No. 10-2005-0078428, filed on Aug. 25, 2005, in the Korean Intellectual Property Office, the disclosure of which is incorporated herein in its entirety by reference.

### BACKGROUND OF THE INVENTION

1. Field of the Invention

The present general inventive concept relates to a vibration absorber, and more particularly, to a vibration absorber which can tune a natural frequency thereof by changing a distribution of mass, and a light scanning unit having the same.

2. Description of the Related Art

In general, apparatuses for reducing a vibration response of a mechanical structure to an exciting force include an active vibration absorber, a passive vibration absorber, or a damper. When the mechanical structure receives the exciting force according to a work environment, a vibration of the mechanical structure can be absorbed by attaching to a vibration portion a vibration absorber having a natural frequency that is the same as a natural frequency of the vibration portion or the exciting frequency transferred to the vibration portion.

U.S. Pat. No. 5,810,319 discloses a conventional apparatus to obtain a natural frequency of a desired apparatus. The disclosed invention is an apparatus for tuning a natural frequency of a vibration absorber to a frequency of a structure by adjusting a tension of a spring supporting a vibrating absorber body. However, the structure of the apparatus is complicated and precision process is needed to obtain the natural frequency of the desired apparatus so that it is difficult to manufacture the apparatus.

U.S. Pat. No. 5,947,453 discloses a conventional spring-mass vibration absorber to absorb a vibration of a structure. However, a structure of the disclosed invention is complicated and it is difficult to manufacture.

European Patent 1,023,544 discloses a conventional apparatus that changes a frequency of a vibration absorber by a movement of a mass. The disclosed apparatus causes a deformation of a support portion by the movement of mass and changes a frequency of vibration by changing a support rigidity according to a generation of stress. The invention is an active type vibration absorber which changes the support rigidity by causing the deformation of the support portion. However, the invention requires an additional driving apparatus and a controller therefore, raising a cost thereof.

Korean Patent Publication No. 2000-0026066 discloses a conventional vibration absorber for supporting a mass using an elastic ring and a rotary reflection mirror, an assembly, and a printer having the vibration absorber. The vibration absorber is applied to the vibration in a radial direction of a rotary body and a tuning of a frequency is not possible.

### SUMMARY OF THE INVENTION

The present general inventive concept provides a vibration absorber which is installed on a mechanical structure exposed to vibration and can easily tune a natural frequency of the vibration absorber, and a light scanning unit having the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a vibration absorber having a support frame installed on a structure, and a damper block portion movably installed on the support frame to change a frequency of the structure according to a position of the damper block portion with respect to the support frame.

The support frame may include a plurality of ends fixed to the structure in a lengthwise direction of the support frame.

The support frame may include a single end fixed to the structure in a lengthwise direction of the support frame.

The damper block portion may include a bracket installed on the support frame to move in a lengthwise direction of the support frame, and a damper block coupled to the bracket to change the frequency of the structure when the bracket is moved.

The support frame may have a guide slot formed therein in the lengthwise direction of the support frame, the bracket may have a coupling hole, and the damper block may have a coupling member formed at a side of the damper block and coupled to the bracket through the guide slot and the coupling hole to fix the bracket to the support frame.

The position of the damper block portion on the support frame may be manually changed.

The foregoing and/or other aspects and utilities of the present general inventive concept may also be achieved by providing a light scanning unit having a vibration absorber having a support frame installed on the light scanning unit, and a damper block portion movably installed on the support frame to change a frequency of the light scanning unit according to a position of the damper block portion on the support frame.

The support frame may include a plurality of ends fixed to the light scanning in a lengthwise direction of the support frame.

The support frame may include a single end fixed to the light scanning unit in a lengthwise direction of the support frame.

The damper block portion may include a bracket installed on the support frame to move in a lengthwise direction of the support frame, and a damper block coupled to the bracket to change the frequency of the light scanning unit when the bracket is moved.

The support frame may have a guide slot formed therein in the lengthwise direction of the support frame, the bracketing may have a coupling hole, and the damper block may have a coupling member formed at a side thereof and coupled to the bracket through the guide slot and the coupling hole to fix the bracket to the support frame.

The position of the damper block portion on the support frame may be manually changed.

The foregoing and/or other aspects and utilities of the present general inventive concept may also be achieved by providing an image forming apparatus, including a photosensitive body, a light scanning unit have a light source to emit light, a beam deflector to deflect the light, an optical member to direct the deflected light toward the photo sensitive body to form a lateral image, a vibration absorber having a support frame installed thereon, and a damper block portion movably installed on the support frame to change a frequency thereof according to a position of the damper block portion with respect to the support frame.

The foregoing and/or other aspects and utilities of the present general inventive concept may also be achieved by providing a light scanning unit usable in an image forming apparatus, including a structure having at least one of a light source, a beam deflector, an optical member, and a photosensitive body, a vibration absorber having a support frame installed on the structure, and a damper block portion coupled to the support frame to change a mass distribution of the vibration absorber.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a light scanning unit according to an embodiment of the present general inventive concept;

FIG. 2 is a perspective view illustrating a vibration absorber of the light scanning unit of FIG. 1;

FIG. 3 is a perspective view illustrating the damper block portion of the vibration absorber of FIG. 2;

FIG. 4 is a perspective view illustrating a vibration absorber according to another embodiment of the present general inventive concept;

FIG. 5 is an image illustrating a result of a simulation of numerical analysis of the vibration absorber of FIG. 2 under a particular condition; and

FIG. 6 is an image illustrating a result of a simulation of numerical analysis by moving the damper block portion of the vibration absorber of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

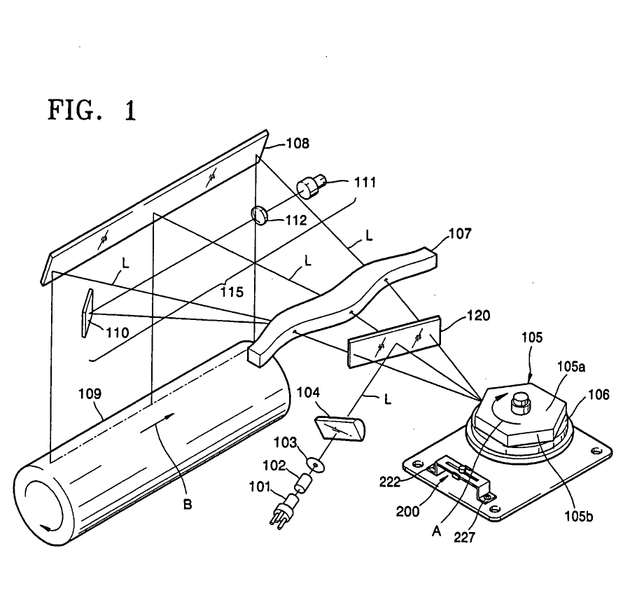

FIG. 1 is a perspective view illustrating a light scanning unit according to an embodiment of the present general inventive concept. Referring to FIG. 1, the light scanning unit scans light with respect to a photosensitive body 109 that rotates, and includes various optical elements such as a light source 101, a collimator lens 102, a slit 103, a cylindrical lens 104, a beam splitter 120, a beam deflector 105, a driving source 106, an f-θ lens 107, an image forming mirror 108, and a sync signal detection portion 115. The light scanning unit is usable with an image forming apparatus to form an image on a printing medium.

The light source 101 generates and emits at least one light L corresponding to an image signal by being controlled to be on/off by a drive circuit (not shown). That is, the light source 101 generates and emits the at least one light L corresponding to the image signal while being controlled by the drive circuit to be on/off such that the light L can be scanned onto only a portion of a light exposed body of the photosensitive body 109, where an electrostatic latent image is formed. The light source 101 may emit a single light or multi-lights. When being adopted in a structure to form a single scan line, the light source 101 has a structure to generate and emit a single light. When being adopted in a light scanning unit to scan multi-lights, the light source 101 has a light source module to generate and emit a plurality of lights that are independently optical-modulated. The light source 101 may be an edge emitting diode, a vertical cavity surface emitting laser (VCSEL), or a light emitting device (LED). Since the structure and operation of the light source 101 is widely known in the technical field to which the present general inventive concept pertains, a detailed description thereof will be omitted herein.

The collimator lens 102 is separated from the light source 101 and concentrates the light L emitted from the light source 101 to form a parallel light or a converged light with respect to an optical axis. The slit 103 is attached to an end surface of the collimator lens 102 and restricts the light L which passes through the collimator lens 102. The cylindrical lens 104 receiving the light L passing through the slit 103 forms a linear image on the beam deflector 105.

The beam splitter 120 is arranged between the beam deflector 105 and the f-θ lens 107 on the same horizontal plane as the beam deflector 105 and the f-θ lens 107, transmits a portion of the light L that passes through the cylindrical lens 104, and reflects the remaining portion of the light L. A half mirror capable of transmitting 50% of the incident light L can be used as the beam splitter 120.

The beam deflector 105 is mounted on a frame 150 and scans the light L reflected by the beam splitter 120 while moving the light L in the horizontal direction at a constant linear velocity. The frame 150 may be a main body of the image forming apparatus or the light scanning unit in which the photosensitive drum 109, the light source 101, and/or other components as described above are installed. The route of the light L incident on the beam deflector 105 is substantially opposite to the route of the light L reflected from the beam deflector 105. When the beam splitter 105 is rotated in a clockwise direction A, the light L is scanned in a main scanning direction B so that image information is recorded on a surface of the photosensitive body 109. The beam deflector 105 may be a polygon mirror device having the structure shown in FIG. 1. The polygon mirror device includes a driving source 106 to rotate a polygon mirror 105a at a predetermined speed. The driving source 106 is mounted on the frame 150 and the polygon mirror 105 is rotatably disposed on the driving source 106. The polygon mirror 105a includes a plurality of reflection surfaces 105b formed on the side surfaces thereof. While rotating, the polygon mirror 105a deflects and scans the incident light L. The beam deflector 105 is not limited to the polygon mirror device configured as above and any device such as a hologram disc type beam deflector or a Galvanometer type scanner which can deflect and scan the incident light can be employed.

The f-θ lens 107 is arranged on an optical axis between the beam deflector 105 and the image forming mirror 108. The f-θ lens 107 is formed of at least one lens unit and corrects the light L deflected by the beam deflector 105 at different magnifications with respect to the main scanning direction B and a sub-scanning direction. The sub-scanning direction refers to a rotation direction of the photosensitive body 109 while the main scanning direction B refers to an axial direction B of the photosensitive body 109 as shown in FIG. 1, that is, a direction in which the light L is deflected by the beam deflector 105. The f-θ lens 107 may be formed of plastic in injection mold to improve productivity and reduce costs.

The image forming mirror 108 reflects the light L passing through the f-θ lens 107 to form an image on the light exposed surface of the photosensitive body 109 that is an image forming surface. The image forming mirror 108 is inclined with respect to a surface formed by the light L incident thereto such that a scanning line heading for the light exposed surface is perpendicular to the sub-scanning direction that is a direction in which the photosensitive body 109 is transferred.

The sync signal detection portion 115 receives some of the light L emitted by the light source 101 and tunes a horizontal synchronization of the scanning light. The sync signal detection portion 115 includes a sync signal detection sensor 111 to receive some of the light L that is deflected by the beam deflector 105 and passes through the f-θ lens 107, a reflection mirror 110 arranged between the f-θ lens 107 and the sync signal detection sensor 111 to change a proceeding path of incident light toward the sync signal detection portion 115, and a condensing lens 112 to condense the light L reflected by the reflection mirror 110 into the sync signal detection portion 115.

A vibration absorber 200 is installed at a side of the light scanning unit with the beam deflector 105. In the image forming apparatus having the light scanning unit, the light scanning unit receives an exciting force due to an external (or internal) force created by the rotation of the beam deflector 105 or an operation of other constituent elements such as the photosensitive body during printing, or from a printing environment. In a vibration system in which the external force (an exciting force component) is acting, when an exciting frequency of the external force becomes identical to a natural frequency of a structure such as the light scanning unit, an amplitude of the vibration system increases exponentially as time passes. That is, when the exciting frequency of the external force becomes identical to the natural frequency of a structure such as the light scanning unit, resonance is generated so that the structure is severely shaken. When the structure is severely shaken due to the resonance, light cannot be scanned onto an accurate position. Thus, a print quality is deteriorated and a life span of the light scanning unit is reduced. When a structure such as the light scanning unit receives the exciting force, the vibration absorber 200 absorbs vibration by changing the natural frequency of the structure. That is, the vibration absorber 200 according to the present general inventive concept that is attached to the structure such as the light scanning unit reduces a vibration response of the structure. The vibration absorber 200 may be disposed on a first portion of the frame 150, and the beam deflector 105 maybe disposed on a second portion of the frame 150. The frame 150 may be mounted on the light scanning unit. The vibration or force occurs from the beam deflector 105 or other components of the image forming apparatus. The structure and operation of the vibration absorber 200 is described below in a case where the structure to which the vibration absorber 200 is attached is the light scanning unit.

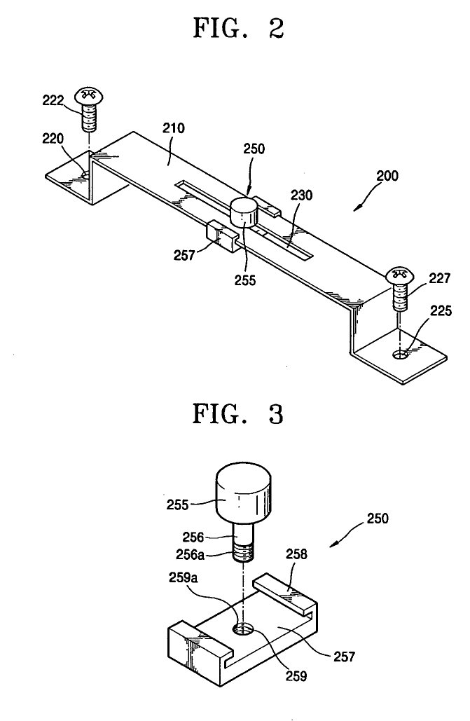

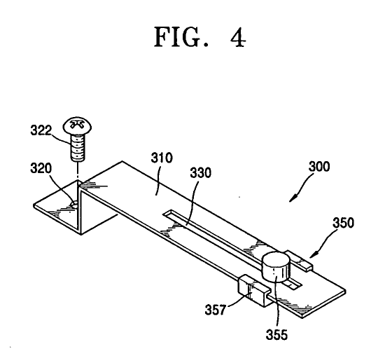

FIG. 2 is a perspective view illustrating the vibration absorber 200 of FIG. 1. FIG. 3 is a perspective view illustrating a damper blocking portion 250 of the vibration absorber 200 of FIG. 2. FIG. 4 is a perspective view illustrating a vibration absorber according 300 to another embodiment of the present general inventive concept.

Referring to FIG. 2, the vibration absorber 200 according to an embodiment of the present general inventive concept includes a support frame 210 installed on a structure, such as a main body of the image forming apparatus or the frame 150 of the light scanning unit of FIG. 1, and a damper block portion 250 movably installed on the support frame 210 and changing a frequency of the structure while moving with respect to the support frame 210. The frequency signifies the natural frequency of the structure.

In the present embodiment of the general inventive concept, both ends of the support frame 210 are installed on the structure and the center portion of the support frame 210 is separated from the structure so that the damper block portion 250 can freely move when the support frame 210 is installed on the structure. That is, the support frame 210 has a shape of a section of a hat. The support frame 210 includes a main portion disposed in a longitudinal (lengthwise) direction, end portions extended downward from opposite ends of the main portion, and the both ends coupled to the structure. Thus, the hat shape has a horizontal top surface connected at each end to a horizontal bottom surface by a vertical surface. Coupling holes 220 and 225 are provided at both ends of the support frame 210 in a lengthwise direction thereof so that the support frame 210 is fixed to the structure using a coupling member such as bolts 222 and 227. Also, a guide slot 230 to fix the damper block portion 250 to the support frame 210 is formed in the main portion of the support frame 210. The guide slot 230 is formed in the lengthwise direction of the main portion of the support frame 210 so that the damper block portion 250 is moved along the guide slot 230.

Referring to FIGS. 2 and 3, the damper block portion 250 includes a bracket 257 installed on the support frame 210 to move in the lengthwise direction of the support frame 210 and a damper block 255 coupled to the bracket 257 to change the natural frequency of the structure by changing the natural frequency of the vibration absorber 200 during the movement of the bracket 257. The damper block portion 250 is installed on the support frame 210 to move with respect to the support frame 210 according to the environment in which the damper block portion 250 is used or other printing environment of the light scanning unit. As the damper block portion 250 moves, a mass distribution of the vibration absorber 200 changes so that the natural frequency of the vibration absorber 200 is changed.

When the exciting frequency applied to the structure becomes similar to the natural frequency of the structure, the vibration of the structure gradually increases. Thus, when the exciting frequency becomes similar to the natural frequency of the structure, the natural frequency of the structure needs to be changed to prevent the increased vibration of the structure. When the damper block portion 250 is moved, the mass distribution of the vibration absorber 200 is changed so that the natural frequency of the structure is changed. Accordingly, a particular frequency component existing in a predetermined frequency range is absorbed so that vibration transmitted to the structure can be absorbed. That is, when the damper block portion 250 is moved, the natural frequency of the structure where the vibration absorber 200 is installed is changed so that the vibration due to the excitation can be prevented. For example, when the natural frequency of the vibration absorber 200 is tuned to the natural frequency of the structure, the vibration transmitted to the structure is absorbed by the vibration absorber 200. As the mass distribution of the vibration absorber 200 is changed by moving the damper block portion 250, the natural frequency of the vibration absorber 200 is tuned to the natural frequency of the structure, and a particular frequency component existing in a predetermined frequency range is absorbed, so that the vibration of the structure where the vibration absorber 200 is installed is absorbed.

As described above, by adjusting the position of the damper block portion 250, the natural frequencies of the vibration absorber 200 and the structure can be tuned within a predetermined range. That is, when the damper block portion 250 is moved along the support frame 210, a property of the mass of the vibration absorber 200 changes so that the natural frequency of the vibration absorber 200 is changed. Thus, the vibration applied to the structure can be prevented using the above method.

A coupling step 258 is provided at the bracket 257 to be slidably coupled to the support frame 210. The bracket 257 is coupled to the support frame 210 through the coupling step 258. The coupling step 258 is provided at both sides of a main plate of the bracket 257 to limit a movement of the bracket 257 in a direction other than the lengthwise direction. That is, the support frame 210 is inserted between the main plate and the coupling steps 258 of the bracket 257. A coupling member 256 is coupled to the bracket 257 through the guide slot 230 and a coupling hole 259 to fix the bracket 257 to the support frame 210 and is provided at a side of the damper block 255. The coupling member 256 extends toward the coupling hole 259 from a side of the damper block 255. For example, as shown in FIG. 3, a screw 256a is formed in a portion of the coupling member 256 to be inserted in the coupling hole 259. The screw 256a may be coupled to a screw 259a formed in the coupling hole 259 so as to fix the bracket 257 to the support frame 210.

In order to change the natural frequency of the structure to a desired frequency, the damper block portion 250 may be manually controlled. That is, the vibration absorber 200 may be a passive type of a vibration absorber.

As shown in FIG. 2, the vibration absorber 200 is installed at the structure from both ends thereof in the lengthwise direction. When the structure such as a beam is installed on a mechanical equipment from both ends thereof, a change in strength according to the movement of mass is smaller than a case of installing from one end. That is, a rate of change in strength according to a change in length is smaller in the case of single end support than in the case two ended support. Thus, when the vibration absorber 200 is installed at the structure from both ends thereof, the frequency can be more accurately tuned than in the case of the single end support.

Referring to FIG. 4, a vibration absorber 300 according to another embodiment of the present general inventive concept may be installed at a structure from one end thereof in the lengthwise direction. The vibration absorber 300 includes a support frame 310, a coupling hole 320, a bolt 322, a guide slot 330, a damper block portion 350, a damper block 355, and a bracket 357. Since a structure and operation of the vibration absorber 300 of FIG. 4 are similar to those of embodiment shown in FIGS. 2 and 3, detailed descriptions thereof will be omitted herein.

To review an effect of the vibration absorber 300, a simulation, that is, numerical analysis, was performed by changing the position of the damper block portion using a computer simulation, such as an ABAQUS tool (a tool using a commercial software package for finite element analysis developed by ABAQUS, Inc.) or other finite element analysis software. For the convenience of explanation, the vibration absorber 200 of FIG. 2 is used in the simulation.

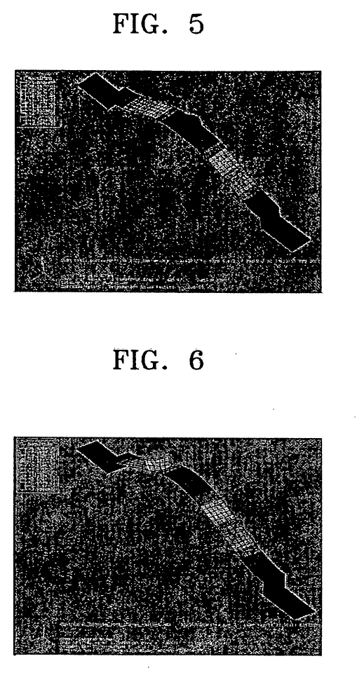

FIG. 5 illustrates a result of a simulation of numerical analysis of the vibration absorber 200 of FIG. 2 under a particular condition. FIG. 6 illustrates a result of a simulation of numerical analysis by moving the damper block portion 250 of FIG. 5. In FIG. 5, the result of numerical analysis is based on a case in which the damper block 255 is located at a center of a span of the support frame 210 when the span, thickness, and beam width of the support frame 210 are 100 mm, 0.5 mm, and 5 mm, respectively, and the mass of the damper block 255 is 10 g. In FIG. 6, the result of the numerical analysis is based on a case in which the damper block 255 is deviated from the center of the span of the support frame 210 by 25 mm when the span, thickness, and beam width of the support frame 210 are 100 mm, 0.5 mm, and 5 mm, respectively, and the mass of the damper block 255 is 10 g. When the damper block 255 is located at the center of the span as illustrated in FIG. 5, the vibration absorber 255 shows a frequency of 266.17 Hz. When the damper block 255 is deviated from the center of the span by 25 mm as illustrated in FIG. 6, the vibration absorber 255 shows a frequency of 309.43 Hz. That is, as shown in the simulations, when the vibration absorber 200 is installed on the structure and the damper block portion 250 is moved, the natural frequency of the vibration absorber 200 is changed. However, respective conditions of the simulations have been arbitrarily set to explain an effect of the present general inventive concept and a scope of technology of the present general inventive concept is not limited by the results of the simulations.

Although in the present embodiments of the general inventive concept the structure and operation of the vibration absorber is described on the assumption that the structure is a light scanning unit, the structure on which the vibration absorber is installed is not limited thereto. For example, the vibration absorber may be installed on various mechanical structure such as a hard disk drive or an image forming apparatus. That is, the scope of technology of the present general inventive concept is not limited by the embodiments shown in the accompanying drawings.

As described above, according to the present general inventive concept, without changing a strength of a vibration absorber, natural frequencies of the vibration absorber and a structure thereof can be changed by moving a damper block portion installed on the vibration absorber.

As described above, a vibration absorber according to the present general inventive concept and the light scanning unit having the same can be manufactured without a precision process because a natural frequency thereof can be tuned by a movement of a mass, not by changing a strength thereof, unlike as required by the conventional technology. Also, since according to the present invention the frequency of the vibration absorber can be tuned by manually moving a damper block portion, the vibration absorber can be used in mechanical structures operating under various working environments.

As described above, a vibration absorber according to an embodiment of the present general inventive concept has a variety of frequencies when a damper block portion is moved. Thus, the vibration absorber can be installed on a variety of mechanical structures which operate in a wide range of frequencies. Also, the frequency of the vibration absorber can be changed by manually moving the damper block portion, a natural frequency can be applied to different products because of the design allowance of a mechanical structure or a process error. That is, since the frequency of the vibration absorber can be changed, the difference in the natural frequency for each product generated due to the process error can be allowable.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A vibration absorber, comprising:
a support frame installed on a structure; and
a damper block portion movably installed on the support frame to change a frequency of the structure according to a position of the damper block portion with respect to the support frame.

2. The vibration absorber as claimed in claim 1, wherein the support frame comprises a plurality of ends fixed to the structure in a lengthwise direction of the support frame.

3. The vibration absorber as claimed in claim 1, wherein the support frame comprises a single end fixed to the in a lengthwise direction of the support frame.

4. The vibration absorber as claimed in claim 1, wherein the damper block portion comprises:
a bracket installed on the support frame to move in a lengthwise direction of the support frame; and
a damper block coupled to the bracket to change the frequency of the structure when the bracket is moved.

5. The vibration absorber as claimed in claim 4, wherein:
the support frame comprises a guide slot formed therein in the lengthwise direction of the support frame;
the bracket comprises a coupling hole; and
the damper block comprises a coupling member formed at a side thereof and coupled to the bracket through the guide slot and the coupling hole to fix the bracket to the support frame.

6. The vibration absorber as claimed in claim 1, wherein the position of the damper block portion on the support frame is manually changed.

7. A light scanning unit having a vibration absorber, the vibration absorber comprising:
a support frame installed on the light scanning unit; and
a damper block portion movably installed on the support frame to change a frequency of the light scanning unit according to a position of the damper block portion on the support frame.

8. The light scanning unit as claimed in claim 7, wherein the support frame comprises a plurality of ends fixed to the light scanning unit in a lengthwise direction of the support frame.

9. The light scanning unit as claimed in claim 7, wherein the support frame comprises a single end fixed to the light scanning unit in a lengthwise direction of the support frame.

10. The light scanning unit as claimed in claim 7, wherein the damper block portion comprises:
a bracket installed on the support frame to move in a lengthwise direction of the support frame; and
a damper block coupled to the bracket to change the frequency of the light scanning unit when the bracket is moved.

11. The light scanning unit as claimed in claim 10, wherein:
the support frame comprises a guide slot formed therein in the lengthwise direction of the support frame;
the bracket comprises a coupling hole; and
the damper block comprises a coupling member formed at a side thereof and coupled to the bracket through the guide slot and the coupling hole to fix the bracket to the support frame.

12. The light scanning unit as claimed in claim 7, wherein the position of the damper block portion on the support frame is manually changed.

13. An image forming apparatus, comprising:
a photosensitive body; and
a light scanning unit have a light source to emit light, a beam deflector to deflect the light, an optical member to direct the deflected light toward the photo sensitive body to form a lateral image, a vibration absorber having a support frame installed thereon, and a damper block portion movably installed on the support frame to change a frequency thereof according to a position of the damper block portion with respect to the support frame.

14. A light scanning unit usable in an image forming apparatus, comprising:
a structure having at least one of a light source, a beam deflector, an optical member, and a photosensitive body;
a vibration absorber having a support frame installed on the structure; and
a damper block portion coupled to the support frame to change a mass distribution of the vibration absorber.

15. The light scanning unit of claim 14, wherein the structure has a frequency, and the vibration absorber changes the frequency of the structure to a second frequency according to a location of the damper block portion with respect to the support frame.

16. The light scanning unit of claim 14, wherein when the location the damper portion is changed, a strength of the vibration absorber is not changed.

17. The light scanning unit of claim 14, wherein the vibration absorber absorbs a force exerted to the structure and corresponding to a frequency range according to the location of the damper block portion with respect to the support frame.

18. The light scanning unit of claim 14, wherein:
the structure comprises a frame,
the beam deflector is disposed on a first portion of the frame, and
the support frame is disposed on a second portion of the frame.

19. The light scanning unit of claim 18, wherein the first portion and the second portion are disposed on the same surface of the frame.

20. The light scanning unit of claim 14, wherein the beam deflector generates an exciting force component while deflecting light of the light source with respect to the optical member, and the vibration absorber absorbs the exciting force.

21. The light scanning unit of claim 20, wherein the exciting force component corresponds to the frequency of at least a portion of the structure.

22. The light scanning unit of claim 21, wherein the at least one portion of the structure comprises the beam deflector.

23. The light scanning unit of claim 14, wherein the structure comprises a rotating element to generate a frequency corresponding to a natural frequency thereof, and the vibrations absorber changes the frequency according to the changed mass distribution.

24. The light scanning unit of claim 14, wherein the beam deflector receives a beam from the light source in a first beam path and deflects the beam in a second beam path, and the vibration absorber is disposed in a portion of the structure other than the first beam path and the second beam path.

25. The light scanning unit of claim 14, wherein the vibration absorber prevents vibration according to a frequency generated from a portion of the structure.
